(19) United States
(12) Patent Application Publication
(10) Pub. No.: US 2012/0179531 A1
(43) Pub. Date: Jul. 12, 2012

(54) Method and System for Authenticating and Redeeming Electronic Transactions

(76) Inventor: Stanley Kim, San Diego, CA (US)

(21) Appl. No.: 13/345,727

(22) Filed: Jan. 8, 2012

Related U.S. Application Data
(60) Provisional application No. 61/431,443, filed on Jan. 11, 2011.
(60) Provisional application No. 61/471,126, filed on Apr. 2, 2011.

(51) Int. Cl. H04L 9/32; G06Q 30/06; G06Q 30/02

(52) U.S. Cl. 705/14.26; 726/6; 705/26.1

(57) ABSTRACT

The present inventions relates to systems and techniques for authenticating or redeeming an electronic transaction, particularly through a mobile conduit.

### CROSS REFERENCE TO RELATED APPLICATIONS

This application claims the benefit under 35 U.S.C. §119(e) to U.S. Provisional Application Ser. No. 61/431,443 filed Jan. 11, 2011 and U.S. Provisional Application Ser. No. 61/471,126 filed Apr. 2, 2011.

### FIELD OF THE INVENTION

The present inventions relates to systems and techniques for redeeming an electronic transaction, particularly through a mobile conduit.

### BACKGROUND OF THE INVENTION

The present invention relates to electronic transactions and, in particular to techniques for facilitating redemption of electronic transactions, particularly for local small businesses having minimal technological infrastructure.

The transaction of many products and services are increasingly performed through mobile devices, especially those directed toward consumers. Electronic tickets, receipts and coupons are promoted and validated through a number of mechanisms to authenticate, track and/or redeem these transactions, including barcodes, text-based confirmations, (SMS or email or web-based), and the like. Many businesses simply send a message or token to the user to use to use as the voucher or ticket for the transaction (see, e.g., WO/2003/063528). Many, however, require active (or passive) authentication of the transaction by the business (see, e.g., US Pat. App. Nos. 20110302107 and 20110302018). This generally requires a dedicated peripheral device by businesses, including barcode readers, scanners, computers with internet access, telephones and the like. For example, US Pat. App. No. US20080300970 describes a system for a business to redeem coupons through its phone system by authenticating a code transmitted to the consumer's mobile phone.

Although such systems accomplish the task of authentication and/or redemption, they also create barriers to the widespread adoption of such systems, particularly for small, local businesses that often have nothing more than a cash register. Such systems are generally resource expensive requiring a cohesive infrastructure, which may be prohibitive for many smaller businesses, or require multiple steps to authenticate the coupon. Even large businesses find the inconvenience of inputting codes, particularly coupons, incompatible and dissuasive to readily and robustly adopt such systems—especially for large chains where efficiency is more important than confirming authenticity of a coupon.

Accordingly, there is still a need for systems to manage transactions between customers and businesses electronically on demand that is more accessible, efficient, cost-effective and less susceptible to fraud and abuse.

### SUMMARY OF THE INVENTION

According to various specific embodiments of the present invention methods and apparatus are provided for authenticating an electronic transaction through a mobile conduit. The electronic transaction is for a service or product represented electronically as a ticket, coupon, receipt, bet, or similar message. Accordingly, the system is activated by a user, such as a consumer, upon purchase, acquisition, gift or request by the user of a service or product. Upon activation, the invention system transmits (e.g., via text message or alternate electronic message) a confirmation of a transaction to the user on user's mobile device as part of a first communication. When the user desires to redeem the electronic confirmation for the service or product, user displays confirmation to the provider, such as a business or merchant, whereupon a second communication authenticates transaction for provider (directly or indirectly) to activate or confirm transaction through second communication to system transmitted through users mobile device. System receives authentication identifier, validates or confirms authentication by matching the information provided in second communication against information stored in the system regarding the transaction, provider and/or user. Verification of the transaction is confirmed and sent through a third communication to user's mobile device, which can be displayed on user's mobile device and shown to provider, and preferably expiring or terminating the validity of the transaction. Optionally, in series or in parallel, confirmation and reporting are also provided to provider through various peripheral devices, including mobile phone, email, internet or website associated with the provider.

### BRIEF DESCRIPTION OF THE DRAWINGS

FIG. 1 is a flowchart illustrating interaction between a user's mobile device and a redemption system according to a specific embodiment of the invention.

FIG. 2 is a diagram illustrating exemplary communications between the user's mobile device and the redemption system in which embodiments of the present invention may be implemented.

FIG. 3 is a diagram illustrating portals for activating the system pursuant to a user's (or registrant's) initiation of a transaction.

FIG. 4 is a diagram of a sample webpage illustrating a template for provider to the system to automatically generate an offer webpage.

FIG. 5 is a list or cheat sheet for users to interact with the system through text messages.

FIG. 6 depicts the system for redeeming an incentive program.

FIG. 7 illustrates a system and method for automatically redeeming transactions.

### DETAILED DESCRIPTION

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well-known features may not have been described in detail to avoid unnecessarily obscuring the invention.

In a preferred embodiment of the present invention, there is provided a system and method for redemption and authentication by a provider of a product, service, payment and/or the like acquired or purchased by a customer or consumer. More specifically, there is provided a system and method whereby a provider of a service or product (e.g., vendor or merchant or manufacturer and the like) can authenticate the validity of a transaction through a series of electronic communications through a consumer's mobile device. Even more specifically, consumer receives a confirmation communication of a purchase made by consumer on consumer's mobile device from a central access server, enabling the redemption of a product, service, payment and/or the like in a controlled fashion, further whereby the vendor will authenticate the redemption of the purchase via consumers mobile device.

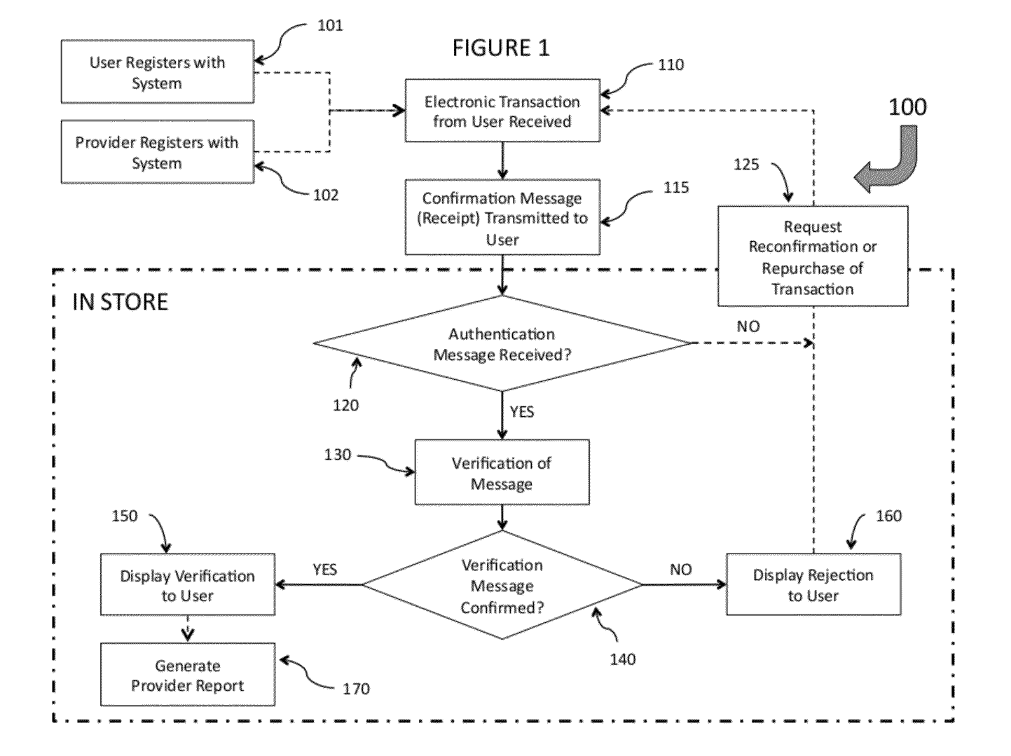

As illustrated in FIG. 1, the present invention 100 acts as a conduit for a series of communications between a computer system, such as a server, and a mobile device. Upon the occurrence of a transaction 110, a user will be sent a receipt 115 of the transaction through a first communication to user's mobile device. Generally, the receipt 115 will be stored on user's mobile device or retrievable by mobile device upon redemption event. Process 100 awaits further action by user to activate or authenticate transaction 120. User will then present the receipt of the transaction to the provider of the product or service to initiate physical redemption, whereupon a second communication 120 will be sent to system to user's mobile device. Although physical display is preferred, as described herein, user may initiate redemption temporally and/or geographically near the provider. User may request a duplicate copy or repurchase of the transaction 125 by sending message to the system to send or resend receipt (e.g., confirmation of transaction) 115. The second communication 120 may contain information about the transaction, the user, the provider or the mobile phone or such other identifiers for the system to verify 130 the information for redemption of the transaction. A third communication 140 authenticating the transaction is sent back to the user's mobile device verifying the validity 150 or the rejection 160 of the transaction, which can be presented to provider to complete the transaction. This verification message 140 may provide information about the user, the provider, the transaction or the mobile phone, or such other information for provider to complete the transaction. Confirmation of the redemption can be provided to provider separately as yet a separate message or as a report available online 170.

In a preferred embodiment of the present invention, the system is populated with information about users and providers, and completed and potential transactions. Accordingly, referring once again to FIG. 1, the user and the provider registers with the system (101 and 102, respectively) prior to any communications by the system to the mobile device of the user. A user may be a consumer, client, recipient, registrant or such other individual desiring a deal or a transaction. For example, user may be a consumer looking for a product or services, or a concertgoer attending an event, or winner of an auction. A user may also be an entity or a group with the same desire. User may or may not also be the same user that completes a transaction, for example a parent (in this example, the registrant registers into system) may buy a meal for their child (user but not direct registrant with system), or User may be the recipient of a donation or gift. User may preregister directly or may be preregistered by another individual or group (for example, a school or tour group), in response to an offer or may register at the time of the redemption. According to a particular implementation, user may provide general and/or personal information about themselves, but more importantly, information pertinent to the transaction, such as the product, offer code, service or payment, volume, amount to be paid (for example for auctions) payment information such as credit card or banking information or other online account information such as PAYPAL®, address, mobile number, email or other online user information, or combinations thereof. In a more particular implementation, user provides one or more phone numbers to the system, such as their phone number or the phone number of the individual redeeming or completing the transaction (e.g., the mobile number of the child in the above example). In addition, the phone number(s) may correspond to any of a variety of communication devices such as, for example, conventional landlines, mobile devices (e.g., cellular phones, smart phones, etc.), IP phones, etc.

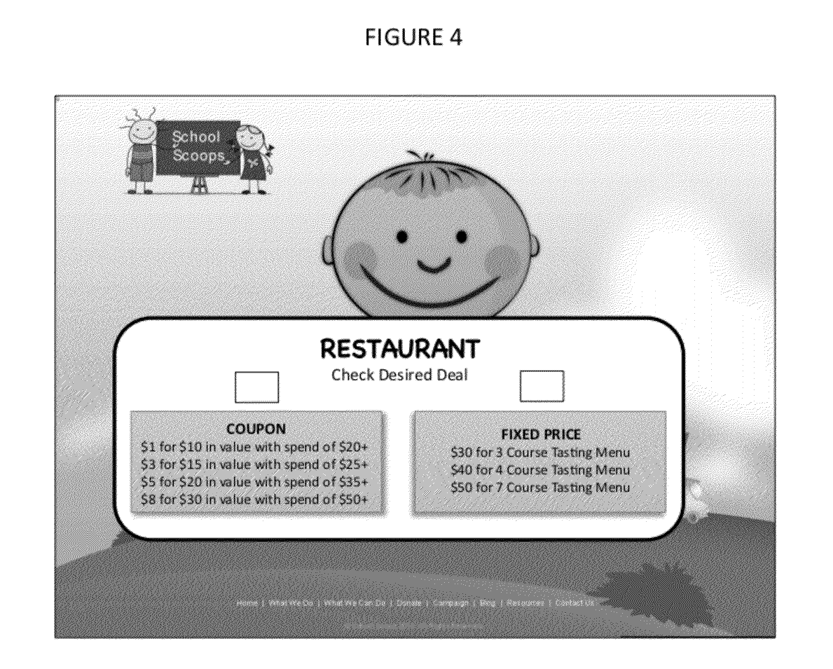

A provider may be an individual, merchant, manufacturer, advertiser or marketer, a business or such other individual or entity providing the product, service, payment or the like. Provider will register such information pertinent to the transaction including its address, and, preferably, the terms of the transaction. The transaction can be for a variety of goods such as for a product, service, payment, bet, prize, discount, admission, auction, or access to, participation in, or use of an event or venue, and the like. In a particular implementation, once registered with the system, the provider may specify one or more transactions for electronic distribution by the invention system or an outside system that feeds into the invention system. This will typically involve the provider specifying the terms of such transaction including, for example, business rules according to which distribution and redemption of the transaction are to be facilitated. For example, the provider might specify that all users within a particular geographic area (e.g., a zone defined by the location of the advertiser's business) be presented with a coupon for a specified percentage off particular goods or services. More generally, virtually any technique by which a transaction may be generated and distributed may be employed with various embodiments of the invention. For example, the offer for the transaction can be generated individually for each provider or generated as a template on the system. As shown in FIG. 4, in yet an alternate preferred embodiment, the invention comprises a process for enrolling providers wherein a template is created by the system (either self populating, survey of provider or as a general base template) based on characteristics of the provider, for example, based on location, type of provider, and the like.

Provider's addresses and phone numbers also may be entered into the system. Such information obviously is useful for the transaction, billing and reporting purposes, and for creating a unique provider identifier. Preferably, however, a provider's address and phone number will be included in one or all of the communications to assist consumers in redeeming any purchased transactions. The address preferably is a street address, but less detailed or specific location information also may be entered if users are able to rely on that information to locate a provider, e.g., GPS link. As discussed in detail below, the address information also may be used to define location values that will be used by the system to identify transactions of interest to a consumer. In a more particular implementation, provider provides one or more phone numbers to the system, such as the phone number of the business. The phone number(s) for the provider may correspond to any of a variety of communication devices such as, for example, conventional landlines, mobile devices (e.g., cellular phones, smart phones, etc.), IP phones, etc. Upon registration, a provider may be assigned or designated a unique provider identifier based on this information that will enable the system to more effectively identify transactions to each user and provider.

In a detailed perspective of the present invention, user (or a representative of user) initiates the redemption process by electronically purchasing (generally purchasing, buying, donating or donated, winning, acquiring, renting, leasing, gifting or gifted, requesting, and the like) an offer for a good, product, service, payment and the like. For example, user may purchase online a coupon for a discount for dinner for a local restaurant advertised or promoted to user, or such other item as sales incentives, rebates, vouchers, redeemable gift certificates, coupons, advertisements, raffles, auctions, freebies, discounts, and the like, and particularly include sales incentives such as BOGO (or Buy One (or more) Get One (or more)), punch cards, discounted gift certificates, discounted coupons, and the like.

It will be appreciated that the offer or promotion can be presented to user in a variety of means, including verbal, telephonic, TV or radio, mobile, electronic or written, including such methods as email, text, flyers, requests, social media tools, newsletters, advertisements, and the like. The electronic transaction will register with system. Generally, users will desire an electronic copy of the receipt, e.g., as a confirmation. Accordingly, user will be provided an electronic receipt or message confirming transaction which can be printed or displayed/stored electronically in the form of an email receipt, an electronic document such as a .pdf copy, a mobile receipt in the form of a message, a link to a website, and the like, or combinations thereof. A thread of such receipts showing any and all transactions can be also stored locally on user's computer or mobile device, or online through a user's web or online account. Preferably, the confirmation of electronic transactions is communicated to users through users mobile device such as through a text message, email, document, a link to open a mobile browser, or a mobile application.

The mobile communications device may be a mobile telephone including smart phones, personal digital assistant (PDA), text messaging enabled pager, or other mobile communications device capable of displaying a message and optionally accepting an interactive response. Although the present invention uses the illustration of a mobile device, any wireless device as further elaborated below such as iPods®, tablets, such as iPad® or Kindle®, mobile gaming devices such as Gameboy®, navigation systems, laptops or portable laptops, and the like are contemplated for completing the transaction.

In a preferred embodiment of the present invention, confirmations (and more generally, the communications of the system) are sent through a mobile device. Each communication can take the form of any electronic message, including a text message, an email, Tweet®, an application, a link to a browser, webpage, portable document, audio or video message, image, and the like. Preferably, the message will be provided through a text message service such as SMS (short message service), EMS (enhanced message service), MMS (multimedia message service) and the like. Short Message Service (SMS), supported by most mobile devices, allows alphanumerical messages of up to 160 7-bit ASCII characters to be transmitted to or from a subscriber via a cellular network. In the mobile terminal case the message is typically displayed on the mobile terminal upon reception. On the mobile terminal the last received message can be stored in non-volatile memory. The SMS provides procedures for receiving, reading, editing, clearing, storing and sending messages. The network ensures resending of the SMS message in case of transmission failure once the mobile terminal is reachable again. SMSs can also be used to access various services from a portable device such as a browser or application. For example, EMS (Enhanced Messaging Service), an extension of the SMS, provides SMS with functionalities such as text formatting (bold or italic fonts) and limited picture and animation support. If an EMS is sent to a phone that doesn't support it, it will display as a standard SMS. MMS stands for Multimedia Messaging Service and this type of text messaging is an evolution of the SMS. With a MMS, you can send a message including pictures, video or audio content to another device. It is very useful to send a photo taken with a camera phone to another phone. Most new cell phones with multimedia capabilities support MMS. Because the size of the message is defined in kilobytes, a MMS can contain a lot more information than a SMS. There are other protocols by which mobile telecommunication devices are able to transmit text messages over mobile telecommunications networks, however, and such protocols may be used to the exclusion or in addition to SMS text messaging. For example, NTT DoCoMo's ShortMail service and Softbank Mobile's SkyMail service in Japan provide text messaging using other protocols, and RIM's BlackBerry® service in the United States uses standard mail protocols such as SMTP over TCP/IP which are used in less mobile electronic mail devices.

The level of detail provided in the communication will depend on the type of communication. Applications and emails may contain images and greater levels of detail, but generally, for example with SMS text messages, the basic information to initiate the transaction is sufficient. For example, the name of the provider and/or the user, the address of the provider, the date transaction is purchased, the mode and identifying information of the payment made, the amount and/or value of the transaction (for example, one coupon purchased for $5 for $50 of services or goods), information about the product, service, payment or the like, a transaction identifier such as a code, instructions to redeem the transaction, and the like, may be warranted as part of the confirmation message, as well as combinations or abbreviations, slang, acronyms, initials, representations and the like of this information. Generally, information such as the time and the date, as well as sender information is inherently provided in the message as part of the message, although this may be expressly included as well. However, additional information such as a link to an online map (e.g., Google Map) or a GPS coordinate, or a picture of the store, or a link to review or other such pertinent information, are also contemplated as part of the confirmation message.

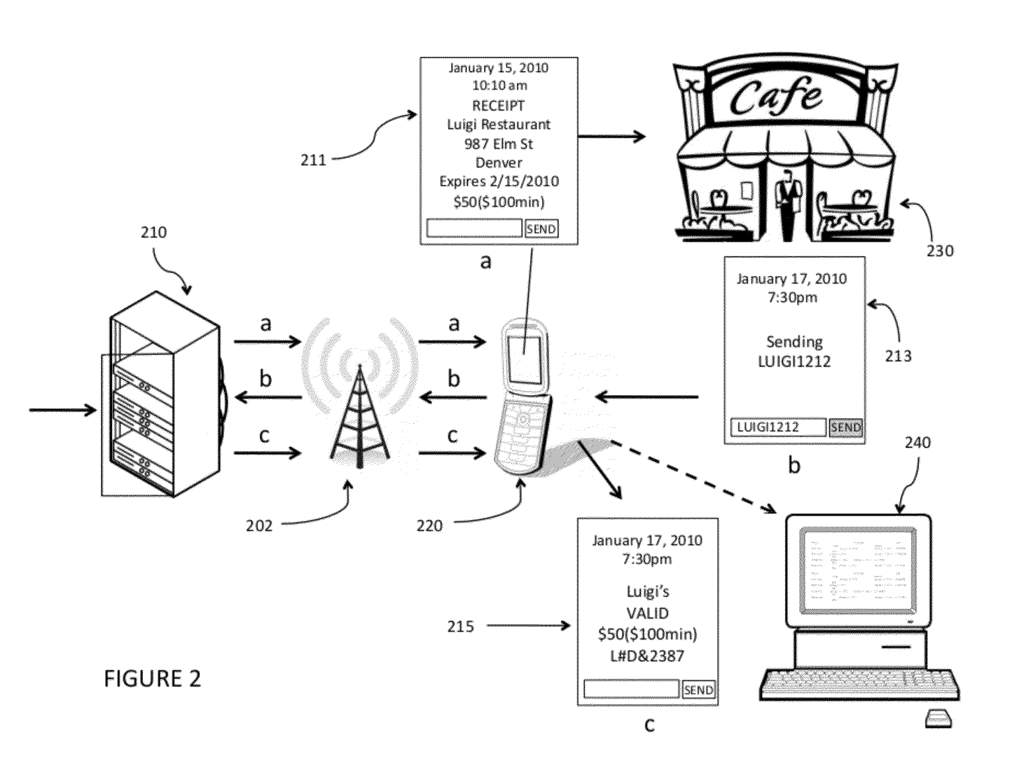

Referring to FIG. 2, redemption of a transaction will generally occur at a physical location 230. For many businesses, presentation of a confirmation alone may be insufficient to warrant redemption of the transaction, requiring further authentication to avoid fraud and abuse. It may be desirable or necessary for authentication of a transaction in order to mitigate, prevent or discourage duplication or unauthorized use. Accordingly, additional authentication and verification of the transaction may be necessary, preferably in the presence of the provider (which includes their representatives such as their employees, agents, etc.). In a preferred embodiment, when the user wishes to redeem the transaction, the user presents user's mobile device 220 to display the confirmation message 211 to the provider at the provider's place of business 230. According to various embodiments, this presentation may take a variety of forms. For example, in an implementation in which the confirmation message 211 is issued to the user via an SMS message, the user may simply display the confirmation message 211 on the screen of the user's mobile device 220 to the provider or a representative of the provider (e.g., a waiter or cashier) 230. Alternatively, if the user received the electronic confirmation message on user's computer, he may print it out and bring it to the provider's place of business 230. As will be appreciated, the confirmation message 211 may be presented to the provider 230 in any of a wide variety of ways without departing from the scope of the invention.

Continuing to refer to FIG. 2, regardless of how the confirmation message 211 is presented to the provider 230, the provider (directly or indirectly by user or provider's representative) 230 effects redemption by initiating an authentication message 213, e.g., an email reply or text message reply, or opening a service through user's mobile device 220 such as a browser or an application, or a phone call to the system 210, in which the authentication message 213 is transmitted to the system 210 in response to the confirmation message 211. This authentication, generally manual, may be accomplished in a variety of ways without departing from the invention. For example, provider 230 could reply on user's mobile device 220 a provider identifier, e.g., an identifier such as the phone number of the provider, the name of the provider, password, code, and the like, that could be compared against the information stored for the provider/transaction as part of the registration process. Alternatively, a link within the confirmation message 211 can open a browser that would require the provider to login with login information, which may require a password. This information can be input by the user or the provider. In yet another alternative, a link within the confirmation message 211 can open an application that may request the provider identifier or other such information.

In a preferred embodiment, the identifier may comprise a series of digits, such as numbers or alphanumeric digits. Since today's mobile communication devices can include sophisticated keyboards and text entry methods, the provider identifier selected can comprise a variety of symbols, characters, data, etc.; however, to ensure that the identifier operate over the broadest range of mobile communication devices, the digits comprising the provider identifier established should be limited to data that can be input via a simple telephone keypad. Accordingly, in one preferred embodiment, the digits comprising the provider identifier should be limited to the numbers 0-9 and/or letters A-Z, which are often associated with numbers on a simple cellular phone keypad as will be understood. In yet an alternative embodiment, the provider identifier is all or part of a phone number entered by the provider. That is, for example, the provider identifier could be a complete phone number, e.g., 1-111-111-1111, or just some part of the number, e.g., the last 4 digits. Alternatively, the provider identifier could be a distinct name and/or number identifying the provider, such as a franchisee and their store number. In yet another embodiment, the provider identifier is a string of multiple random characters unique to the transaction, e.g., a specific identifier for each transaction and/or user. Accordingly, in a preferred embodiment, a unique provider identifier can correspond to each provider, user, employee or other representative of provider, transaction, day and/or time, and the like, or combinations thereof. Generally, the identifier can be available to the provider prior to the redemption, for example, upon registration or daily/weekly/monthly as a list. The level of uniqueness for the identifier will depend on the level of scrutiny desired or required, balanced by other factors such as the ease for a provider to remember the identifier, sufficient room for instructions and other transactional information, and the like. Preferably, the system will accommodate low security memorable identifiers such as phone numbers or simple codes to accommodate the expiration of the transaction.

In yet another embodiment, the identifier may comprise an image, a sound or such other non-textual information, such as a barcode or picture. For example, the provider may have a universal barcode or other visual identifier that can be captured with user's mobile device, particularly a camera phone that is able to acquire and utilize barcodes. A universal barcode can be sent to provider for each transaction, promotion, provider and/or location. In yet another example, many mobile communication devices are capable of automatically or passively registering their location, for example, through global positioning systems (GPS), wi-fi or other wireless network, proximity markers such as IP addresses and the like. Some devices are capable of storing location information in the form of cookies or otherwise. Accordingly, a provider identifier may include information derived from GPS and other such systems or stored in the device, either reduced to text characters in the text message itself, as hidden text or embedded code, or as an attachment to the text message. Any automatically registered data, however, may register a user's current location even if it does not coincide with the area in which he is or will be shopping. Thus, manually entering the location as text characters, converting automatically generated location information to text characters that can be edited, registering wireless information from the provider's location or IP address, or querying the user of the desire to authenticate; may be preferred. A user then would be able to identify a location other than his current location or the stored information, where he expects to redeem a transaction.

Again referring to FIG. 2, once the authentication message 213 is received by the system 210 from user's device 220, the information from the authentication message 211 received by the system 210 is verified against information in the system 210. This verification may be achieved in a variety of ways such as, for example, mapping any and all information in the authentication message 213 to information in the system 210 to authenticate and verify the transaction. For example, the system 210 may determine whether the user's mobile number and the provider identifier correspond to a valid transaction for that user and provider. Although greater information will enable the system 210 to more efficiently map the authentication message 213 to each transaction and/or user, even simple SMS messages (that do not attach or reconvey previously sent messages) will include the user's mobile number and the originating number (e.g., the phone number from system) and the time sent. This information can be used to identify the user and the validity (non-expiration, for example) of a transaction. If user has multiple transactions, the system 210 can use multiple unique phone numbers for each transaction that will be “passively” relayed back to system upon reply by the user/provider. For example, seven distinct system numbers (e.g., telephone numbers) can be associated with one user for each of seven transactions at any one time. More preferably, however, reply from the user's mobile device with a provider identifier (e.g., text, image, location, audio or such other information) will enable a greater level of authentication and verification of each transaction. Alternatively, such level of detail (e.g., verification of each transaction) may not be necessary, instead only requiring the confirmation of the user and generally, the terms of the transaction (e.g., a user purchases seven coupons that are not individually accounted for, only in volume).

Although the above examples rely on text messages, it will be obvious to those of skill in the art that other modes of communication such as email, webpages, mobile pages or applications, or other functions of more capable mobile devices such as smart phones, will enable greater levels of detail and authentication. For example, a link in an email or SMS in the confirmation message will enable the user/provider (again, directly or indirectly) to open a browser on a web-enabled mobile phone and enter information on a webpage/website. Applications such as mobile applications are also contemplated where location information can be exchanged by “bumping” of user's device with provider's device, or simply require an action from the provider or user to take upon redemption. It will also be obvious that existing peripherals are also contemplated, for example, barcode scanners and the like.

Verification of the authentication message 213 can be associated with a unique transaction by the system 210, which may further reveal the user, the provider and the terms of the transaction. As further illustrated in FIG. 2, the authentication message 213 may be verified by the system 210 as coming from the user to whom transaction was issued, and more preferably, as being redeemed in the presence of the provider 230 that authorized the issuance of the transaction. Once the authorization message 213 is verified, the system 210 determines whether the authentication corresponds to a valid transaction. The results of this determination are then communicated to the user as a verification communication 215, i.e., a message is displayed on user's mobile device 220 indicating as valid or invalid, which can be displayed or presented to provider 230.

As with the authorization flow, verification communication 215 may be achieved in any of a variety of ways. As will be understood, presentation of the verification to the user, and subsequently to the provider 230, may be achieved in a variety of ways depending on the context in which the conditions are satisfied or the event occurs. The verification message 215 can be displayed on user's mobile device 220 as a text message such as a SMS message, an email, a link to open a webpage on a browser, an electronic attachment such as a .pdf document, a prompt for an application, and the like. For example, if the user has a cell phone 220 that is enabled for web browsing, the verification message 215 could be transmitted as an object embedded in a web page or in an mobile application. A wide variety of other suitable mechanisms will be apparent to those of skill in the art. In embodiments in which the user might have multiple transactions with the same provider, the system 210 may determine and communicate the validity of all transactions having the user's information with one set of communications, e.g., “Valid for 10 Uses”. Alternatively, the user could be prompted to redeem multiple transactions each independently.

It will be appreciated that SMS text messages have the advantage of near instantaneous delivery, especially when transmitted directly from the system to a telecommunication device, particularly through a wide area network 202. This enables the system 210 to be responsive to immediate needs of consumers. Other types of electronic mail systems, such as those relying on standard mail protocols transmitted through the Internet, may not be delivered as quickly. Thus, and also because of their availability on mobile communication devices and networks in which the invention has particular advantage, text messages and especially SMS text messages are a preferred protocol for receiving redemption requests.

The verification information in the verification communication 215 will vary and may include any information deemed pertinent by a provider 230 to redeem the transaction. It preferably includes at a minimum such terms as are legally sufficient to define the offer that a transactions represents. Accordingly, offer information may, and usually will include such information as a product description and/or the price or discount to be applied. If the transaction is for entry or admission for an event or venue, the relevant information in the verification message can include the name of the user, the purchase price, the date, and the name or identifier for the event or venue. If only certain merchants or locations will honor an offer, for example, specific franchisees, that information also will be included. Offer information also may include expiration dates, limits, and other terms and conditions imposed by a provider. It may include offer codes to assist in tracking the effectiveness of campaign, and usually will include such codes if a manufacturer, franchisor, or other third party will reimburse a provider who honors the electronic transaction. It may also include a transaction identifier that may be unique to that particular user, transaction or transaction type, the provider, and the like. In yet an alternate embodiment, the verification may be time dependent requiring user to display verification (transaction) within a specific time period).

In one exemplary embodiment, assuming user/provider replied to the confirmation message, the authentication message to the system will contain at least the user's mobile number, the originating number (e.g., phone number from system), and time sent, which can be used to identify a transaction purchased on the system and awaiting redemption. If so, a verification message is sent to user's mobile device, enabling user to verify transaction to provider, and redemption of transacted good, product, service, payment, and the like. Once redeemed, a transaction may be invalidated or expended by the system to avoid subsequent attempts to redeem the same transaction. Preferably, use of the system will terminate, invalidate or expire the transaction to discourage hacking, phishing or such other random or intentional input of identifiers. If the authentication message cannot be verified, or the transaction is determined not to be valid, the transaction is rejected.

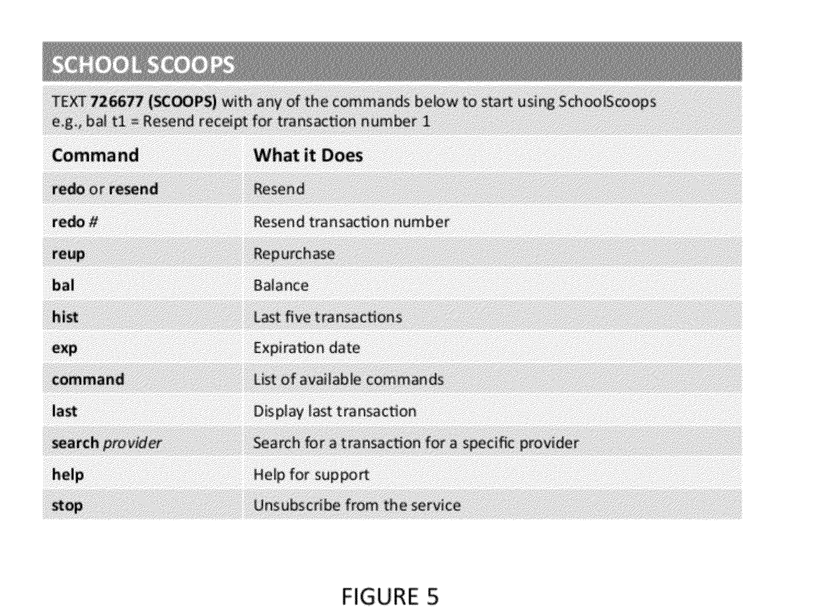

According to a specific embodiment, even where a transaction is indicated to the provider as being invalid or rejected, the provider may still want to allow redemption of the transaction. In such a case, the provider may be given the option to override the rejection of the transaction, e.g., by yet another communication to the system, in response to which, redemption of the transaction is effected, and resent in a verification message to the user's mobile device as a valid transaction. Alternatively, user may initiate a transaction by initiating a communication with the server to contest rejection or determination of invalidity, repurchase transactions, or increase number of transactions, and the like. As shown in FIG. 5, user can interact with system to enable a variety of functions, such as repurchasing new transactions, searching transactions, downloading historical information or outstanding transactions, and the like.

In accordance with other preferred aspects of the invention, the system preferably makes a record of each request and/or redemption analyzes that data to facilitate managing transaction and providing additional enhancements to the service. For example, the system preferably makes a record in the database of transactions redeemed or distributed for each provider. That record may be used to determine outstanding transactions, redemption patterns and other consumer habits, and the like. This information can also be shared with provider by email reports, by facsimile, as an online report accessible by provider, and the like. Thus, unlike conventional electronic transaction, the novel methods can virtually assure that the provider will have current information. Further information not based on actual transactions may also be extracted including distribution patterns, geographic spending patterns, demographics information, and the like. Thus, even if the transaction is not redeemed, the merchant still receives the benefit of having distributed a branding message.

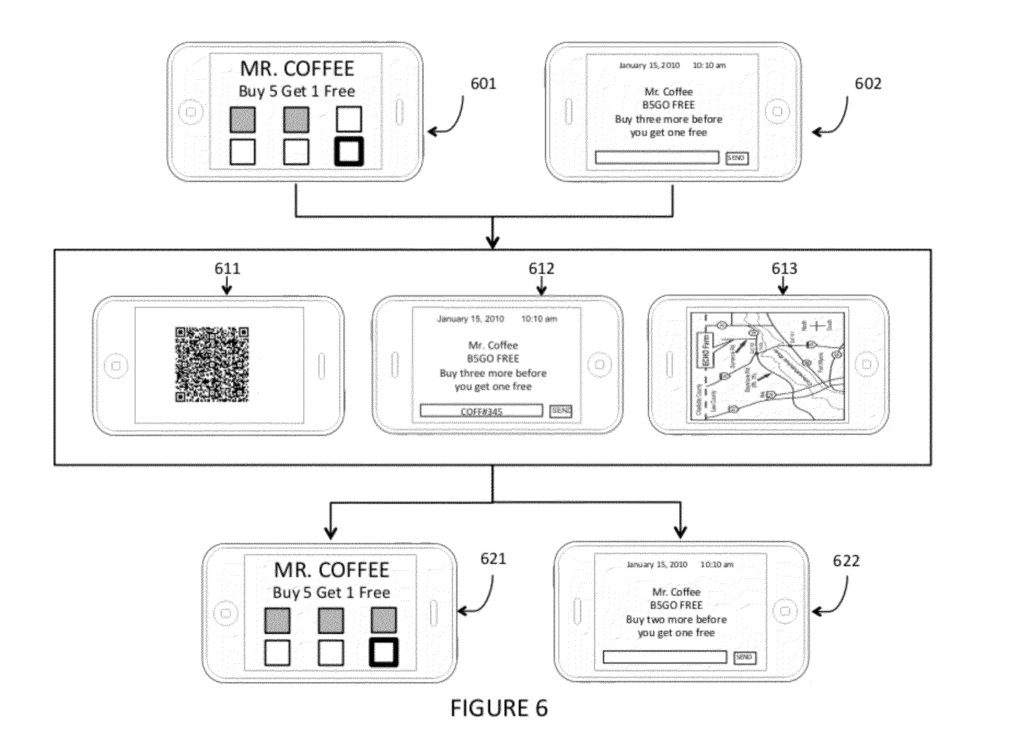

FIG. 6 shows a particular embodiment of the present invention validating the purchase of a product and incentivizing consumers to make purchases. FIG. 6 shows an incentive transaction where the consumer purchases a certain number of products or services before getting a particular item or such other item free. This may be used to replace stamps or punch cards traditionally found in many establishments. This can be performed as a web page, a mobile application 601, SMS text message 602 or other mobile presentation. Upon purchase of a product or service, the provider can directly or indirectly verify the purchase of the item(s). For example, this can be verified by the consumer's mobile device by the barcode 611 or RFID of the item or the provider (e.g., a barcode specific to the provider for the transaction), by a verification code by the provider 612 or indirectly based on localization tools such as GPS 613, and the like, or combination thereof. Upon verification, a message can be relayed back to the consumer's mobile device confirming the transaction, which will be registered on the mobile device or on the system 621/622. Preferably, as throughout, the system can manage a single or multiple transactions.

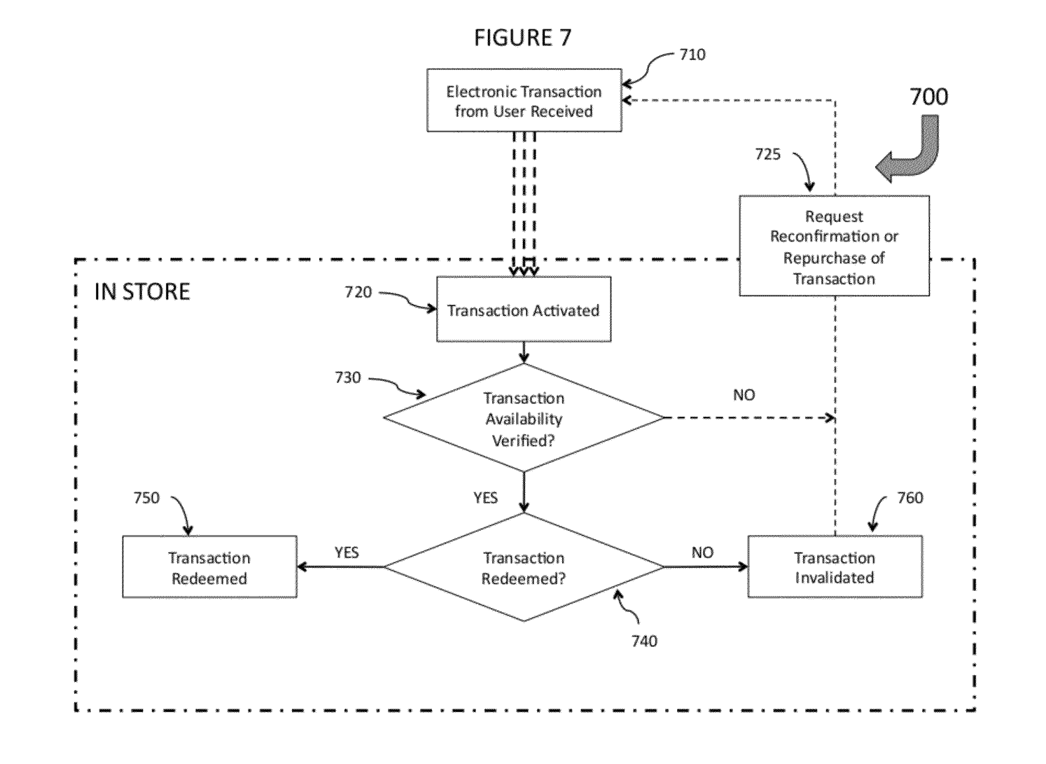

FIG. 7 shows an alternate embodiment of the present invention. In the present invention, there is provided a system and method for automatically redeeming transactions. Upon purchase of a transaction, the user may or may not receive a confirmation of a transaction 710. Upon the desire to redeem transaction with the provider, user (or provider) activates the transaction 720. Activation 720, as above, can be manual (e.g., by manually authenticating or inputting identifier, code or other input) or automatic (e.g., geo-activation (activated on-site), sensors, etc.). The system confirms the availability of the transaction 730. If available 740, the transaction is redeemed with the provider 750. If unavailable 760, the system requests reconfirmation or repurchase of the transaction 725. Preferably, the transaction is time dependent or location dependent (or combination of both), requiring the user to redeem the coupon within a specific time or location (e.g., by redeeming with provider). Transaction is invalidated if user is outside of temporal or spacial parameters, for example, if not redeemed within a specific time period or in a certain location. Such invalidation can be displayed (or deleted, modified, etc.), for example by automatic removal of transaction (e.g., coupon removed or invalidated) or display of expiration of transaction, or by the provider acknowledging expiration of transaction (e.g., this coupon is only good on a specific date), or such other method of notifying provider/user that transaction is no longer valid. Preferably, a timer is displayed with the activation to notify user of life of the transaction. In a preferred specific embodiment, user activates a transaction and is notified that user has a specific time allotment (e.g., 5 minutes) to redeem coupon with provider. If redeemed within parameters, transaction is recorded for user and/or provider to manage. If not redeemed within the parameters, the transaction is invalidated. User may be able to reactivate the transaction through the system, as described above or such other method designated by the system.

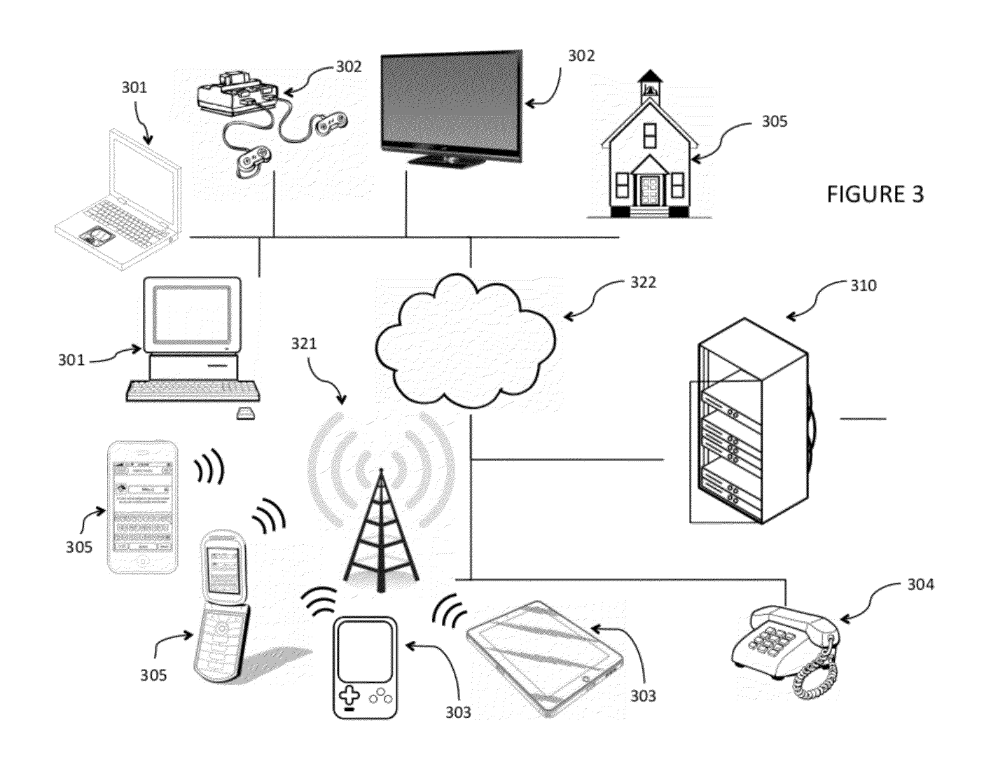

It should be noted that various aspects of the present invention might be implemented using any of a wide variety of communication devices and computing platforms, in any of a variety of network types (or combinations thereof), and in any of a wide variety of contexts in which the issuance and redemption of electronic transactions are useful functionalities. Computing devices on which the communications may be implemented may include a central processing unit, memory, input devices (e.g., keyboard and pointing devices), output devices (e.g., display devices), and storage devices (e.g., disk drives). The memory and storage devices are computer-readable media that may contain computer executable or program instructions that implement the present redemption system. For example and as illustrated in FIG. 3, systems which implement the invention redemption method which may include the transmission of electronic transactions (issued and/or redeemed), and which users and providers may interact with include personal computers 301, media computing platforms 302 (e.g., gaming platforms, or cable and satellite set top boxes with navigation and recording capabilities), handheld computing devices (e.g., PDAs or handheld gaming platforms) 303, conventional land lines 304 (wired and wireless), mobile (e.g., cell or smart) phones 305, or any other type of portable communication or computing platform (e.g., vehicle navigation systems). Such transactions may be resident on some of these devices, e.g., in connection with a browser, messaging, or other application, or be served up from a remote site, e.g., in a web page or a messaging application. In addition, a redemption system 210 (represented by server and data store) may be accessible to the various types of devices either directly or indirectly via a wide variety and/or combination of network environments and protocols (represented by network 302) including, but not limited to, TCP/IP-based networks, plain old telephone system (POTS) networks, telecommunications networks, wireless networks, satellite networks, etc. In addition, the data structures and message structures may be stored or transmitted via a data transmission medium, such as a signal on a communications link. Various communication links may be used, such as the Internet, a local area network, a wide area network, a point-to-point dial-up connection, a cell phone network, and so on. There might also be 3rd party redemption systems 305 also contemplated which might issue transactions using APIs to access the relevant data.

An exemplary system according to the present invention consists of a server, also referred as an integrated mobile application server and communication gateway. Server may be implemented, for example, by using a general-purpose computer or a personal computer. Server may be connected to a network, such as one or more of a local area network (LAN), a wide area network (WAN), and the Internet. Server includes a database of user profiles, a database of provider profiles, a transaction database, a communication gateway, an authorization and queue application, and the like. Optionally, server may contain additional features such as a database of potential consumers, community organizations, non-profits or charities or schools, businesses, manufacturers; and other tools such as financial tools, a customer relationship manager (CRM), a neural network or other data-mining tools to extract information from the server. Alternatively or additionally, server may access another server or other memory for any or all of these functions or features. Server may be accessed by a web interface. For example, a user may input a mobile phone number in a web banner as a method of initiating a purchase of a mobile device download, for instance a ringtone, game, picture, video, or other download. Inputting the mobile phone number may access a previously formed account identified by the mobile phone number. The account may include billing information. In the event that no previously formed account for the inputted mobile phone number exists, the web interface may direct the user to set-up an account, by for instance creating a new web interface or redirecting the existing web interface.

While the invention has been particularly shown and described with reference to specific embodiments thereof, it will be understood by those skilled in the art that changes in the form and details of the disclosed embodiments may be made without departing from the spirit or scope of the invention. For example, embodiments have been described herein with reference to the use of conventional landlines and cellular phones. It will be understood, however, that the invention is not so limited. That is, embodiments are contemplated in which a much wider diversity of communication devices may be employed in various combinations to effect redemption.

In addition and although the present invention is particularly advantageous for enabling small local, “brick-and-mortar” businesses to employ tools to attract geographically proximate consumers, the techniques described herein are not necessarily limited to such implementations. For example, embodiments are contemplated in which the provider is an online business or individual for whom the ease of redemption over the phone would be useful, e.g., a seller on an online auction or classified site.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

We claim:

1. A system for redeeming an electronic transaction comprising at least one computer readable medium having computer executable instructions stored therein, wherein the computer executable instructions being configured to transmit a confirmation message to a user, receiving an authentication message from a mobile device in response to the confirmation message, verifying the authentication message, and thereafter transmitting to the mobile device a verification message to enable redemption of the electronic transaction.

2. The system of claim 1 wherein the confirmation message is transmitted to the mobile device of the user.

3. The system of claim 1, wherein said authentication message is manually activated, automatically activated or passively activated prior to redemption by user.

4. The system of claim 1 wherein the messages are transmitted using SMS messages, email and/or a mobile application.

5. The system of claim 1, wherein said authentication message comprises at least one identifier to facilitate verification of the transaction.

6. The system of claim 5, wherein identifier is text based.

7. The system of claim 5, wherein identifier is based on at least one image or barcode.

8. The system of claim 5, wherein authentication is automatically activated by proximity or location based activation.

9. The system of claim 1, wherein system verifies transaction from the phone number of mobile device and date of the authentication message, and optionally an identifier.

10. The system of claim 1, wherein redemption message comprises information relevant for redemption of the transaction.

11. The system of claim 1, wherein said system transmits multiple confirmations to one user each from unique telephone numbers.

12. The system of claim 1, wherein the electronic transaction is a coupon.

13. The system of claim 1, wherein the electronic transaction is a purchase of a good or service.

14. The system of claim 1, wherein the electronic transaction is for an admission to a venue or event.

15. The system of claim 1 further comprising preregistration by a consumer and a provider of the transaction.

16. The system of claim 1, further comprising an activation step, wherein authentication is activated to be time-sensitive or location-sensitive.

17. A computer-implemented method for redeeming an electronic transaction on a mobile device comprising:
a computer system configured to transmit a confirmation message of the electronic transaction to a user,
a computer system configured to receive an authentication message from the mobile device in response to the confirmation message, verify the authentication message, and thereafter transmit to the mobile device a verification message to enable redemption of the electronic transaction.

18. The method of claim 17, wherein the configuration message is transmitted to the mobile device of the user.

19. The method of claim 17, wherein the authentication message comprises at least one identifier, wherein identifier is compared with preregistered information residing on computer system.

20. A system for redeeming an electronic transaction comprising at least one computer readable medium having computer executable instructions stored therein, wherein the computer executable instructions being configured to transmit a confirmation message to a user, receiving an authentication message from a mobile device in response to the confirmation message, verifying the authentication message, and thereafter transmitting to the mobile device a verification message to enable redemption of the electronic transaction.
